(19) United States
(12) Patent Application Publication
(10) Pub. No.: US 2020/0327167 A1
(43) Pub. Date: Oct. 15, 2020

(54) CREATING AND NAVIGATING LINKED INFORMATION

(71) Applicant: Microsoft Technology Licensing, LLC, Redmond, WA (US)

(72) Inventors: Matthew James SMITH, London (GB); Giridharen THARMANANTHAR, Kenilworth (GB); Frederick James Robert WARREN, Wokingham (GB)

(21) Appl. No.: 16/383,328

(22) Filed: Apr. 12, 2019

(51) Int. Cl. G06F 16/901; G06F 16/22; G06F 16/28; G06F 16/26

(52) U.S. Cl. CPC G06F 16/9024; G06F 16/26; G06F 16/288; G06F 16/2264

(57) ABSTRACT

Systems and methods for creating a data graph. One system includes a plurality of data sources and an electronic computing device. The electronic computing device includes an electronic processor configured to generate a data graph for an entity by accessing a plurality of data records stored in a first set of the plurality of data sources. The data graph includes a plurality of connected nodes each including at least one feature representing a dimension of the data graph. The electronic processor is configured to infer an additional dimension for the data graph based on data included in the data graph, and, in response to confirming addition of the additional dimension to the data graph, add data to the data graph associated with the additional dimension by accessing data stored in a second set of the plurality of data sources.

### FIELD

Embodiments described herein generally relate to the creation of data structures for exploring linked information, such as data graphs representing, for example, provenance chains. In particular, embodiments described herein expand on data graphs by identifying and linking related information from various, often disconnected, data sources. The expanded data graph is provided in various user interfaces allowing a user to interact with (view graphically in different formats, query, filter, pivot, and the like) the expanded data graph in intuitive manners, including through the use of verbal commands and physical gestures.

### SUMMARY

Provenance chains provide information regarding the history or journey of an entity or steps involved in the creation of an entity, such as, for example, a physical product such as a car, a digital entity such as digital currency, a music file, a news article, a financial transaction, a person's medical history, a computer software product, or the like. In some embodiments, provenance chains link data (data records) collected about an entity at different stages, which may be collected and provided by one or more organizations, individuals, systems, or the like. For example, for a physical product, a provenance chain may link records collected at various stages of production or distribution of an entity over a period of time, such as from an origin or another starting location or state. Provenance chains can be used for logistical purposes, such as to track the current location of an entity, trace back from a detected contamination, or the like.

Current systems that allow users to create visualizations of provenance chains are limited. For example, these systems are limited to the data explicitly provided for an entity during its creation or distribution (for example, from one or more organizations or individuals or automated scripts or systems supplying reports, databases, or other information relating to an entity or components thereof). For example, a manufacturer of a product may provide a database of records or entries for a product indicating the components or ingredients used, the date of production, the date of shipping, and audit results or other safety or compliance checks. Thus, the provenance chain for this product is limited to the provided entries, which limits the usefulness of the information. Furthermore, once a data graph is generated within a particular system, the visualization forms for the data graph are usually limited and creation of additional visualization forms often requires the re-generation of the data graph, which wastes computing resources.

To solve these and other problems, embodiments described herein expand data graphs, such as provenance chains, to include related information from one or more data sources. For example, as noted above, a manufacturing facility may provide limited information regarding an entity, such as an identifier of the entity and a shipping date of the entity. The manufacturing facility, however, has a location and one or more data sources (for example, not maintained by the manufacturing facility) may provide information regarding the location, such as, for example, weather, traffic, and socioeconomic statistics such as, for example, political status or unrest, labor laws, employee information, or the like. Thus, the systems and methods described herein identify such related information and link the information with a data graph chain to allow a user to interact with this related information. For example, by linking in weather information, a user can interact with a data graph using weather as a dimension although the original data records for an entity did not include such information. In particular, using the linked related information, a user can query for entities that experienced particular weather conditions, such as temperatures exceeding a specified threshold although such information was not directly tracked for the entities in question.

For example, one embodiment provides a system for creating a data graph. The system includes a plurality of data sources and an electronic computing device. The electronic computing device includes an electronic processor configured to generate a data graph for an entity by accessing a plurality of data records stored in a first set of the plurality of data sources. Each of the plurality of data records is explicitly linked to the entity. The data graph includes a plurality of connected nodes and each of the plurality of nodes includes at least one feature representing a dimension of the data graph. The electronic processor is also configured to infer an additional dimension for the data graph based on data included in the data graph, in response to confirming addition of the additional dimension to the data graph, add data to the data graph associated with the additional dimension by accessing data stored in a second set of the plurality of data sources, and store the data graph with the data associated with the additional dimension.

Another embodiment provides a method of creating a data graph. The method includes generating a data graph for an entity by accessing a plurality of data records stored in a first set of the plurality of data sources. Each of the plurality of data records is explicitly linked to the entity. The data graph includes a plurality of connected nodes and each of the plurality of nodes includes at least one feature representing a dimension of the data graph. The method also includes inferring an additional dimension for the data graph based on data included in the data graph, in response to confirming addition of the additional dimension to the data graph, adding data to the data graph associated with the additional dimension by accessing data stored in a second set of the plurality of data sources, and storing the data graph with the data associated with the additional dimension.

A further embodiment provides non-transitory, computer-readable medium including instructions executable by a processor to perform a set of functions. The set of functions includes generating a data graph for an entity by accessing a plurality of data records stored in a first set of the plurality of data sources. Each of the plurality of data records is explicitly linked to the entity. The data graph includes a plurality of connected nodes and each of the plurality of nodes includes at least one feature representing a dimension of the data graph. The set of functions also includes inferring an additional dimension for the data graph based on data included in the data graph, in response to confirming addition of the additional dimension to the data graph, adding data to the data graph associated with the additional dimension by accessing data stored in a second set of the plurality of data sources, and storing the data graph with the data associated with the additional dimension.

### BRIEF DESCRIPTION OF THE DRAWINGS

FIG. 1 schematically illustrates a system for creating and navigating linked information, such as data graphs, according to some embodiments.

FIG. 2 schematically illustrates an electronic computing device included in the system of FIG. 1 according to some embodiments.

FIG. 3 schematically illustrates a user device included in the system of FIG. 1 according to some embodiments.

FIG. 4 is a flowchart illustrating of a method of creating and navigating linked information according to some embodiments

FIG. 5 is an example user interface displaying a visual representation of a data graph according to some embodiments.

### DETAILED DESCRIPTION

One or more embodiments are described and illustrated in the following description and accompanying drawings. These embodiments are not limited to the specific details provided herein and may be modified in various ways. Furthermore, other embodiments may exist that are not described herein. Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way, but may also be configured in ways that are not listed.

Furthermore, some embodiments described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality. As used in the present application, “non-transitory computer-readable medium” comprises all computer-readable media but does not consist of a transitory, propagating signal. Accordingly, non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

In addition, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Moreover, relational terms such as first and second, top and bottom, and the like may be used herein solely to distinguish one entity or action from another entity or action without necessarily requiring or implying any actual such relationship or order between such entities or actions.

As noted above, embodiments described herein provide methods and systems for creating and navigating linked information. As noted above, current systems for exploring provenance chains are limited to information directly tracked for an entity. Thus, the provenance chains provide limited information to users. Furthermore, in many systems only a single visualization for a provenance chain may be provided, which again limits the user's use of the information. Similarly, as available user devices and software applications evolve and enhance, the visualizations of provenance chains provided via these devices and applications may not take full advantage of the newest technology embedded in these devices. For example, systems providing a single visualization format for a provenance chain may display the provenance chain the same on both a mobile device and a smart whiteboard, although a richer visualization may be possible using the smart whiteboard. Furthermore, adapting the visualization to the new device or application may require complete rewriting or structuring of the provenance chain, which wastes human and computing resources.

Accordingly, embodiments described herein provide systems and methods for expanding provenance chains by automatically identifying and linking related information to a provenance chain. For example, even when database entries for an entity do not include temperature information, the systems and methods described herein are configured to link temperature information to the entries using time and location information included in the entries. Embodiments described herein also provide visualization layers that define different ways to render a provenance chain. Accordingly, as the visualization layers are defined and stored separately from the linked information (the expanded provenance chain), linked information can be quickly rendered in different devices and applications. Thus, embodiments described herein reduce the amount of time and processing power required to explore features of a provenance chain and provide improved user interfaces for interacting with provenance chains.

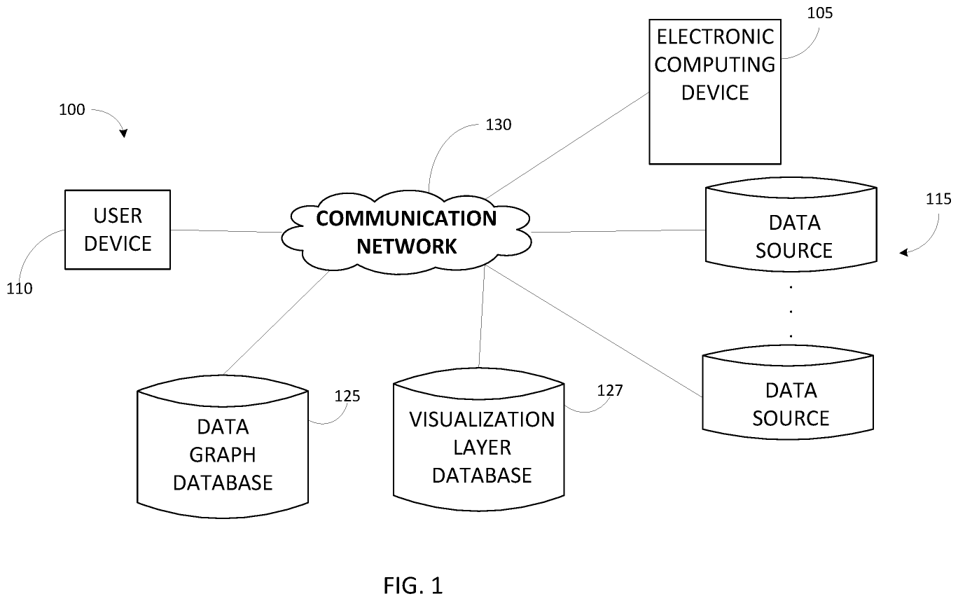

FIG. 1 schematically illustrates an example system 100 for creating and navigating linked information. The linked information is described herein as being a data graph, which may represent a provenance chain for one or more entities. It should be understood, however, that other types of data structures including linked information may be used with the methods and systems described herein.

The system 100 illustrated in FIG. 1 includes an electronic computing device 105, a user device 110, a plurality of data sources (referred to herein as the plurality of data sources 115 or individually as a data source 115), a data graph database 125, and a visualization layer database 127. The electronic computing device 105, the user device 110, the plurality of data sources 115, the data graph database 125, and the visualization layer database 127 communicate over one or more wired or wireless communication networks 130. When implemented wirelessly, portions of the communication networks 130 may be implemented using a wide area network, such as the Internet, a local area network, such as a Bluetooth™ network or Wi-Fi, and combinations or derivatives thereof. In some embodiments, although not illustrated in FIG. 1, components of the system 100 may communicate through one or more intermediary devices, such as routers, gateways, firewalls, or the like.

The plurality of data sources 115 include connected and disconnected data sources in one or more formats or schemas, such as, for example, an Structured Query Language (SQL) database, a graph database, a ledger database, a data lake, and the like. The plurality of data sources 115 or subset thereof may be stored in the same location or in multiple locations owned or operated by the same or different organizations. In some embodiments, the data graph database 125 is also considered one of the plurality of data sources 115. For example, as described in more detail below, after a data graph is created as described herein, it can be used and further expanded as additional data becomes available, including being linked with other data graphs.

It should be understood specific configuration and numbers of components and connections illustrated in FIG. 1 are purely for illustrative purposes, and, in some embodiments, the system 100 includes additional or fewer electronic computing devices, user devices, data sources, and databases. Similarly, in some embodiments, components of the system 100 illustrated in FIG. 1 may be combined and distributed in various ways. For example, in some embodiments, one or more of the plurality of data sources 115, the data graph database 125, the visualization layer database 127, or a combination thereof may be included in the electronic computing device 105.

As described in more detail below, the electronic computing device 105 accesses data stored in the plurality of data sources 115 to create a data graph, such as a provenance chain, and expand the data (dimensions) of the data graph. The created data graph is stored in the data graph database 125. The electronic computing device 105 also creates one or more visualization layers that define how to render a data graph in a particular form, such as, for example, on a map, on a timeline, in a graph, or the like. The visualization layers are stored in the visualization layer database 127. The user device 110 (a driver executed by the user device 110) can access the visualization layer and the data graph from the databases 125 and 127 to access a visualization of the data graph.

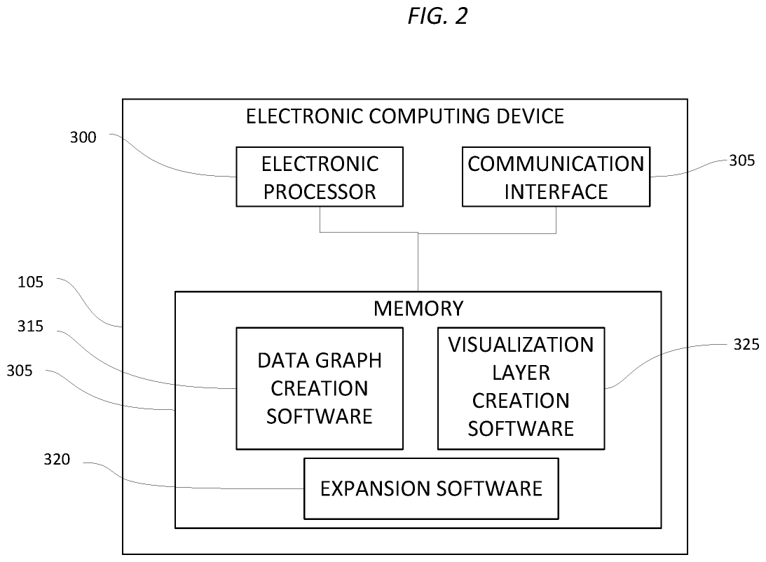

FIG. 2 schematically illustrates the electronic computing device 105 according to some embodiments. As illustrated in FIG. 2, the electronic computing device 105 is an electronic computing device, such as a server, that includes an electronic processor 300 (for example, a microprocessor, application-specific integrated circuit (ASIC), or another suitable electronic device), a memory 305 (a non-transitory, computer-readable storage medium), and a communication interface 310, such as a transceiver, for communicating over the communication network(s) 130 and, optionally, one or more additional communication networks or connections. The electronic processor 300, the memory 305, and the communication interface 310 communicate wirelessly, over one or more communication lines or buses, or a combination thereof. It should be understood that the electronic computing device 105 may include additional components than those illustrated in FIG. 2 in various configurations and may perform additional functionality than the functionality described herein. Furthermore, the functionality described herein as being performed by the electronic computing device 105 may be performed in a distributed nature via a plurality of servers or similar devices included in a cloud computing environment. Additionally, the functionality described herein as being performed by the electronic computing device 105 may be performed by the user device 110.

In the example embodiment illustrated in FIG. 2, the memory 305 includes data graph creation software 315, expansion software 320, and visualization layer creation software 325. The electronic processor 300, when executing the data graph creation software 315, creates a data graph, such as a provenance chain, for one or more entities. Similarly, when executing the expansion software 320, the electronic processor 300 expands a created data graph (adds at least one new dimension) by linking in related information, and, when executing the visualization layer creation software 325, the electronic processor 300 creates a visualization layer for a data graph to display the created and expanded data graph in one of a plurality of visualization forms.

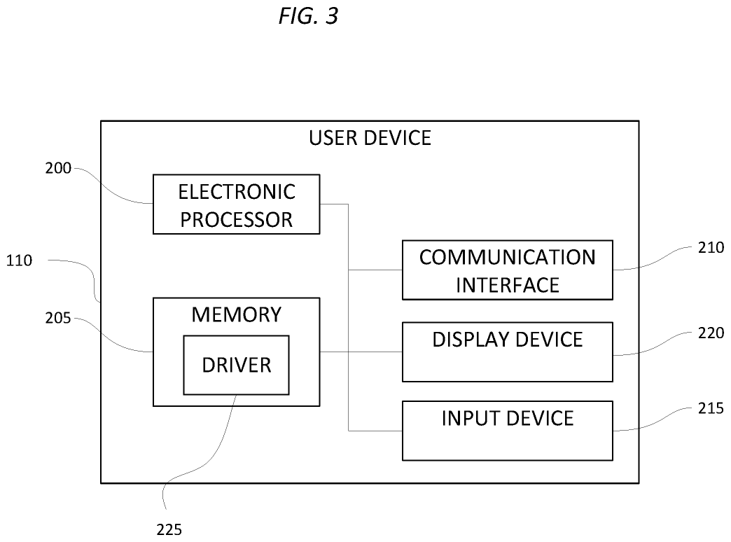

FIG. 3 schematically illustrates the user device 110 according to some embodiments. As illustrated in FIG. 3, the user device 110 is an electronic computing device, such as a desktop computer, a laptop computer, a tablet computer, a smart television, a smart whiteboard, a smart wearable, a virtual reality or augmented reality headset or device, a smart mobile phone, or the like, that includes an electronic processor 200 (for example, a microprocessor, application-specific integrated circuit (ASIC), or another suitable electronic device), a memory 205 (a non-transitory, computer-readable storage medium), and a communication interface 210, such as a transceiver, for communicating over the communication network(s) 130 and, optionally, one or more additional communication networks or connections. The communication interface 210 allows the user device 110 to communicate with the electronic computing device 105 over the communication network(s) 130.

The user device 110 also includes an input device 215 and an output device, such as a display device 220. The display device 220 may include, for example, a touchscreen, a liquid crystal display (LCD), a light-emitting diode (LED), a LED display, an organic LED (OLED) display, an electroluminescent display (ELD), and the like. The input device 215 may include, for example, a keypad, a mouse, a touchscreen (for example, as part of the display device 220), a microphone, a camera, or the like (not shown). The electronic processor 200, the memory 205, the communication interface 210, the input device 215, and the display device 220 communicate wirelessly, over one or more communication lines or buses, or a combination thereof. It should be understood that the user device 110 may include additional components than those illustrated in FIG. 3 in various configurations and may perform additional functionality than the functionality described herein. For example, in some embodiments, the user device 110 includes multiple electronic processors, multiple memories, multiple communication interfaces, multiple input devices, multiple output devices, or a combination thereof.

As noted above, the user device 110 (in response to input received from a user) accesses stored data graphs and associated visualization layers to access a visualization of the data graph in a particular form. The user device 110 may communicate with the electronic computing device 105 or other components of the system 100 using a dedicated software application or a general-purpose application, such as a browser application. As illustrated in FIG. 3, in some embodiments, the memory 205 included in the user device 110 stores a driver 225 that, when executed by the electronic processor 200, applies a visualization layer to a data graph to render one or more forms of visualizations of the data graph. The driver 225 may be stand-alone software or a component of another piece of software, such as an analytics application like Excel, Dynamics 365, Power BI, Azure SQL, or other data platform products provided by Microsoft Corporation or others. It should be understood that, in some embodiments, the driver 225 is stored on the electronic computing device 105 or another server and the visualization is created in a cloud or hosted environment for display on the user device 110 and access by a user.

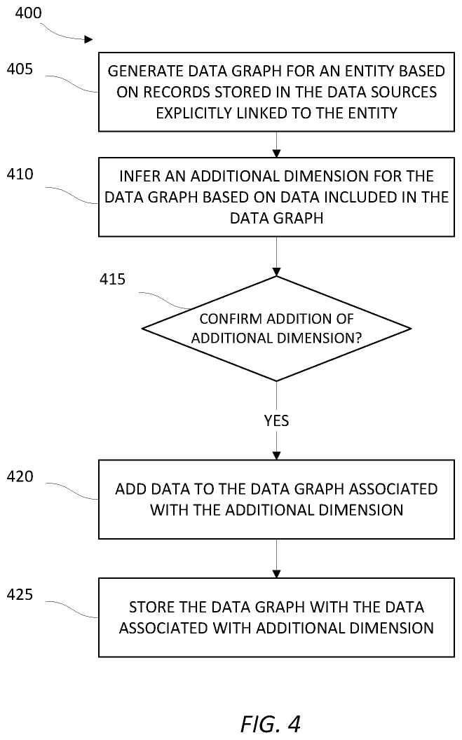

FIG. 4 is a flow chart of an example method 400 of creating and navigating linked information, such as a data graph, associated with an entity. The method 400 is described herein as being performed by the electronic computing device 105 (the electronic processor 300). However, it should be understood that the functionality or a portion thereof illustrated in FIG. 4 may be distributed among a plurality of devices, including, for example, the user device 110, multiple servers, or the like.

As illustrated in FIG. 4, the method 400 includes generating, with the electronic processor 300 (executing the data graph creation software 315), a data graph for an entity (at block 405). The data graph may be a provenance chain that represents the history or journey of the entity, such as a production history, distribution history, or the like. As noted above, the entity may include a physical product such as a car, a digital entity, such as a music file or social media news article, financial transaction, a person's medical history, a computer software product, or the like.

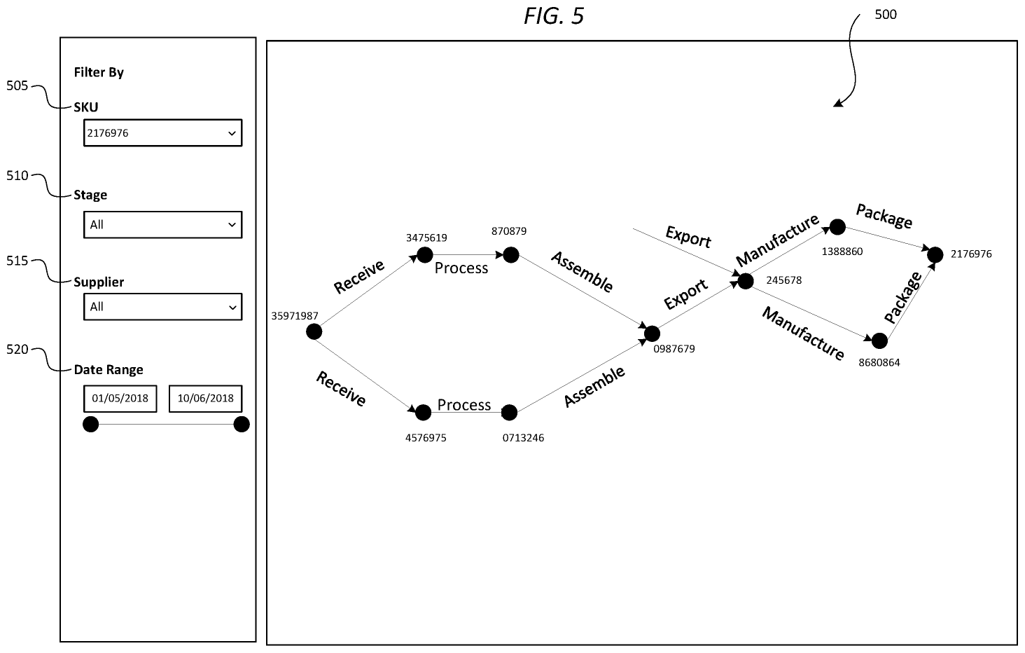

The process of generating a data graph, such as a provenance chain, can be described as “walking the tree.” For example, for purposes of explanation, a data graph, such as a provenance chain, can be described and viewed as including a plurality of connected nodes organized in a tree structure, wherein each of the plurality of nodes represents a stage of an entity, such as a stage of production or distribution, a location, an input or sub-component, or the like. Connections between any two of the plurality of nodes represent connected stages and may represent changes in stages over a period of time, location, or the like. Accordingly, the resulting or final entity in the data graph may represent a root of the tree with other nodes representing branches or leaves in the tree. Also, each node in the tree includes at least one feature, such as a time (date, time, or combination thereof), a stage identifier, an entity identifier, or the like. For example, FIG. 5 illustrates an example data graph 500 that may be created by the electronic processor 300 at block 405. As illustrated in FIG. 5, an entity (product identified by package number 2176976) represents one node on the tree and other nodes represent components or stages that went into the processing, assembling, exporting, manufacturing, and packaging of the entity. It should be understand that a provenance chain can represent a historical path for a single entity or a group of entities that share a common path.

Accordingly, to “walk the tree” and create a data graph, such as a provenance chain for an entity, the electronic processor 300 accesses a plurality of data records stored in a first set of the plurality of data sources 115, wherein each of the plurality of data records is explicitly linked to the entity. In some embodiments, the first set of the plurality of data sources 115 includes one or more data sources provided by one or more organizations or individuals, such as, for example, organizations and individuals associated with a plurality of stages (for example, the production, distribution, or both) of the entity. As used herein, explicitly linked to an entity means that the data record is linked (directly or indirectly) to an identifier of the entity as described below.

For example, using an (unique) identifier associated with the entity in question, the electronic processor 300 accesses the first set of the plurality of data sources 115 to identify one or more data records that include the entity identifier. These records are considered directly linked to the entity. In some embodiments, the electronic processor 300 identifies multiple directly-linked records and generates one or more nodes to represent the records. The electronic processor 300 may also set one or more connections between the nodes based on information included in each record, such as a time.

Furthermore, in some embodiments, the electronic processor 300 may identify other identifiers in the directly-identified records, which may identify further related data records (in the first set of the plurality of data sources 115). For example, a record for an entity (including an entity identifier) may include identifiers to other components, stages, or information associated with the entity. Thus, the electronic processor 300 may use the directly-linked records to identify one or more indirectly-linked records that provide further data associated with the entity. Like the directly-linked records, the electronic processor 300 uses the records to create additional nodes and connections within the data graph. The electronic processor 300 repeats this process identifying further layers of linked records until reaching a stopping condition, such as the lack of any further linked records, a predetermined number of layers or records, or the like.

The electronic processor 300 may perform this “walking” process from a starting point and moving forward in time or stages (for example, from an origin or other starting point) or from an ending point and moving backward in time or stages. In some embodiments, the electronic processor 300 accesses a configuration or other file or dataset that defines what data sources store data records for a given entity and may also define how the electronic processor 300 should trace and collect data to create the data graph. As noted above, information included in the located records may define the relationships and, hence, connections between nodes, such as an identified stage, an identified time, an identified geographic location, or the like included in a record. Alternatively or in addition, the order in which the electronic processor 300 identifies the relevant records may define relationships and connections between nodes, such as by connecting nodes in the order nodes are created from identified records.

As also noted above, each node of the data graph is associated with one or more features, such as a time (for example, a date, a time, or a combination thereof), a geographic location, a facility or organization identifier, a stage type or identifier, test results, audit information, or the like. As described above, the electronic processor 300 pulls these features from the identified records and adds them to each node as applicable. Each feature may represent a dimension on which the data graph may be visualized or interacted with. For example, a time feature may allow nodes of the data graph to be filtered, queried, or otherwise manipulated based on time. Similarly, a stage feature may allow nodes of the data graph to be filtered, queried, or otherwise manipulated based on stage (for example, pre-production, procedure, assembly, shipping, or the like).

As described above, the data graph created by “walking the tree” includes information explicitly recorded for a specified entity. Accordingly, at block 405, the data graph created by the electronic processor 300 includes linked information created from the explicit linkages between data records for the entity. Thus, the data included in the data graph is limited to the data required or elected by the organizations and individuals providing the data, and, thus, is limited in terms of features and, subsequently, dimensions.

Therefore, to expand the original data graph, at block 410, the electronic processor 300 (executing the expansion software 320) determines (infers) one or more additional dimensions for the data graph based on data included in the data graph. The electronic processor 300 may use one or more inference algorithms or rules to infer the additional dimensions. For example, the electronic processor 300 may use a rules-based method that recognizes the most common data formats used to represent various data types, such as geographic coordinates or time and, as described below, look up other data sets including information related to an identified data type that can be linked based on the match. Alternatively or in addition, the electronic processor 300 may use an inference algorithm that predicts the probability of an entity having certain properties, such as temperature, identity, date and time, or the like, to identify inferred data. Such an inference algorithm may be trained using machine learning methods or could use linear interpolation or other forms of interpolation that generate interpolated values that can be used to look up inferred data. For example, as noted above, a node in a data graph may include geographic location information as one feature. Thus, the electronic processor 300 may be configured to recognize the geographical location information in a node of the data graph and identify additional data sources included in the plurality of data sources 115 that store additional information associated with the location. The inferred additional dimension may include weather information (temperature) associated with a location, traffic information associated with a location, or a socioeconomic status associated with a location, such as civil or political unrest, wage or labor laws, news articles or events, or worker satisfaction in a location (or a specific facility).

In some embodiments, the electronic processor 300 may use one or more libraries or web services to infer additional dimensions for a data graph. For example, in some embodiments, the electronic processor 300 uses a different library or web service to infer whether each of a plurality of potential additional dimensions are applicable for a particular node or data graph. For example, the electronic processor 300 may be configured to execute or access a first library or web service to determine whether weather information could be added to one or more nodes of a data graph and may execute or access a second library or web service to determine whether traffic information could be added to one or more nodes of a data graph. Each such library or web service may be configured to infer, from data included in data graph, such as the format of data, a type of data, or a name of data (feature name or identifier) whether a particular dimension is relevant for the data graph.

It should be understood that the additional dimension identified by the electronic processor 300 may include the addition of an additional feature or feature value to an existing node of the data graph, the addition of a new node to the data graph, the addition of a new connection between new or existing nodes of the data graph, or the addition of a plurality of new nodes and connections (such as an existing data graph) to the data graph. For example, through the expansion process, the electronic processor 300 may be configured to identify an existing provenance chain (previously created by the electronic processor 300 or a separate system or application) and add the existing provenance chain as a new connection at block 405.

In some embodiments, the additional dimension identified by the electronic processor 300 may also include an identified duplication or discrepancy, such as when two nodes are associated with two different components or stages with different identifiers but, based on similarities between the identifiers, are likely referring to the same component or stage. For example, when data records associated with an entity are provided by two different organizations, the organizations may create their own unique identifiers or may change the format of an identifier. Thus, these records may not be accurately represented in the original data graph because the identifiers are not identical. To identify these similarities, the electronic processor 300 may be configured to apply a similarity algorithm to the original data graph (or the databases used to generate the original data graph) to detect similarities. For example, when the entity is a product, the electronic processor 300 may be configured to apply a similarity algorithm to databases provided by two organizations involved in the manufacturing or distribution of the product. Applying the similarity algorithm may identify identical times and locations within the databases associated with similar product identifiers.

In some embodiments, when an additional dimension is inferred for a data graph (including the identified duplications or discrepancies), the electronic processor 300 may be configured to automatically add data to the data graph to add the additional dimension (automatically confirm addition of the related data). Alternatively or in addition, in some embodiments, the electronic processor 300 is configured to prompt a user to confirm whether to add an inferred additional dimension. Accordingly, in some embodiments, a user can control how a data graph is expanded. Also, although a user may decide not to add a particular dimension to a data graph during the initial creation of the data graph, the user may later revisit and change the expansion options. Similarly, periodically or as new information becomes available (in the plurality of data sources 115), the electronic processor 300 may re-execute the expansion software 320 to identify further expansions (additional dimensions) for the data graph and, as described above, may prompt the user to confirm whether to apply available expansions.

In some embodiments, the electronic processor 300 determines a probability for an identified additional dimension (including duplication or discrepancy corrections). The electronic processor 300 may use a rules based approach (for example, a rules set), a standard mathematical approach (for example, linear interpolation), machine learning approaches (for example, decision trees), or the like to determine such probabilities. The probability may represent a degree of confidence that the dimension will be useful or relevant to the data graph or fix an actual issue with the original data graph (generally improve the data graph). The electronic processor 300 may calculate this probability by considering a degree of similarity or relatedness to the data graph, user preferences, user history, or the like. In one example, when two locations of an entity are known, the electronic processor 300 may be configured to calculate one or more likely travel paths or pass-through locations (such as other facilities that may not be providing data records) of the entity between the two locations using, for example, a machine learning algorithm trained to predict intermediate locations based on historical data about shipping. In another example, the electronic processor 300 may be configured to determine similar identifiers as described above (for example, associated with an identical time and location) and generate a probability that the identifiers are actually identical (referring to an identical entity, component, or stage). The probability may be provided to a user to aid the user in deciding whether to confirm the addition of the inferred dimension. For example, inferred dimension options presented to a user confirmation may be displayed differently depending on associated probability values. Alternatively or in addition, the electronic processor 300 may use probability values to selectively determine what inferred dimension options to automatically apply, what options to prompt the user for confirmation, what options to ignore, or a combination thereof. For example, the electronic processor 300 may apply one or more thresholds to a probability for an option to determine how to process the options. The probabilities may also be retained (stored with the data graph) and used when generating a visualization of a data graph. For example, nodes, features, or connections between nodes that have particular probability values (below a predetermined threshold) may be displayed differently (for example, with a different color, different format, different animation, or the like) than nodes, features, and connections with other probability values (above the predetermined threshold). Alternatively or in addition, in some embodiments, all nodes, features, and connections added as part of the expansion process may be displayed differently than nodes, features, and connection created as part of the original “walking of the tree” as described above. In some embodiments, the thresholds used by the electronic processor 300 when processing probability values may be configurable, such as by a user or automatically in response to user feedback or history.

Accordingly, in response to confirming the addition of an inferred additional dimension to a data graph (at block 415) (either based on user input or automatic operation of the electronic processor 300), the electronic processor 300 adds data to the data graph associated with the additional dimension by accessing data stored in a second set of the plurality of data sources (at block 420). In some embodiments, the first set of the plurality of data sources 115 (used to “walk the tree” as described above) is distinct (has no identical data sources) from the second set of the plurality of data sources 115. For example, as noted above, data sources used to explicitly track the entity may be used to initially generate the data graph and the additional dimensions may be pulled from other data sources owned or operated by different organizations or individuals unrelated to the entity. In particular, in some embodiments, in at least one data source included in the second set of the plurality of data sources 115 is disconnected from the entity, meaning that data records stored in the data source is not explicitly linked to the entity. For example, weather records stored in one data source may include no direct or indirect identifier of the entity.

In some embodiments, the electronic processor 300 uses the libraries and web services described above that infer additional dimensions to also access data associated with an additional dimension to add or link to the data graph. For example, when an existing node of a data graph includes a geographic location (coordinates) and a time, a web service or library may have a directory of one or more data sources wherein weather data can be accessed for the geographic location and may pull the relevant weather data from these data sources and add the weather data to a node (for example, as a new feature). Thus, the data added to the data graph for the additional dimension is identified based on the additional dimension and existing data included in the data graph. In some embodiments, as part of adding an additional dimension to the data graph, the electronic processor 300 also normalizes data included in the data graph, such as by using a common data format, variable names, definition (unit of measurement), or the like between nodes, features, or both to ensure that when a user issues a query or request on a particular dimension, all relevant information can be quickly and efficiently pulled from the data graph without a need for further processing (translating or aggregating). The electronic processor 300 stores the data graph (with the added data associated with the additional dimension) (at block 425), such as to the data graph database 125. As described above, the stored data graph defines the data included in the data graph, including the links, relationships, and dimensions identified through the expansion process. For example, in some embodiments, the stored data graph includes parent/child relationships between nodes for each dimension of the expanded data graph. In one example, although the original data graph may have only provided stage-based parent/child relationships, the expanded data graph may provide the stage-based parent/child relationships, time-based parent/child relationships, location-based parent/child relationships, and the like. In another example, an originally-created provenance chain of an entity, such as a product, may not include or show all of the branches and, thus, the expanded data graph may show (compared to the original data graph) additional branches to be expanded and explored, additional kinds of information related to a node, and additional fields (parameters or dimensions) related to an entity (product) represented by a node. The expanded data graph may also include additional data along one or more braches of the chain as compared to the original data graph. For example, rather than just showing the temperature associated with one node (such as when only one facility or destination along a path records this information), the expanded data graph may show temperature values all along the provenance chain. An expanded data graph may also include options for viewing information associated with a node, such as how or what information is displayed for one or more nodes included in the chain.

By storing all of these identified dimensions, the data graph can be quickly and efficiently visualized and manipulated. For example, rather than responding to a user query to filter nodes based on a particular dimension by searching one or more data sources to locate the relevant data and mapping the relevant data to the data graph as part of responding to the query, the relationship information included in the stored data graph allows a response to be provided to such a user query quickly and with more efficient use of computing resources and communication bandwidth.

As noted above, in some embodiments, the electronic processor 300 may repeat the expansion process for a data graph stored in the data graph database 125 periodically or as new data becomes available. For example, the electronic processor 300 may be configured to repeat the above described expansion process when an organization involved in the production or distribution of the entity provides new or updated information, a new data source becomes available or accessible by the electronic processor 300, or the like.

As described above, to allow for different visualizations or renderings of the data graph, the electronic processor 300 may be configured to create one or more separate visualization layers for a created data graph. For example, in some embodiments, the electronic processor 300 (when executing the visualization layer creation software 325) creates a visualization layer for one or more types of visualizations or renderings available for a data graph (which may be defined for all data graphs or based on the data or structure of the data graph). Each visualization layer may provide a standard way of defining data included in the data graph for a particular type of visualization or rendering. For example, one of the available visualizations may include a two-dimensional or three-dimensional map and the visualization layer for this type of visualization may map data included in the data object to locations (positions) on the map. Similarly, for a visualization that provides a timeline view, the visualization layer may map or tag data included in the data graph to particular locations or aspects of the timeline. Thus, the visualization layers define features for plotting or mapping data included in the data graph to a particular type of visualization or rendering. Accordingly, the visualization layers can represent cached views including metadata defining how data included in a particular data graph can be visualized and explored. As noted above, creating the visualization layer separate and distinct from the data graph allows the data graph to be generated once and used for multiple types or forms of visualizations, including new types of visualizations that may be developed for new technology. The electronic processor 300 may store the created visualization layers to the visualization layer database 127. Similar to the libraries and web services described above that may be used to infer potential expansions (dimensions) for a data graph, in some embodiments, the electronic processor 300 uses different libraries or web services to translate a data graph to a particular visualization type as part of a creating a visualization layer.

Using a data graph (stored in the data graph database 125) and, in some embodiments, an associated visualization layer (stored in the visualization layer database 127), the user device 110 can create and output a visualization of a data graph for user interaction. For example, as noted above, a driver 225 stored on the user device 110 (for a specific software application, type of user device, or the like) can access a stored data graph and an associated stored visualization layer (for a type of visualization selected by a user or used by default for the user device 110) and use the data graph and the visualization layer to create and output a visualization of the data graph to a user (via the display device 220). However, it should be understood that a visualization of a data graph may be output without using a visualization layer associated with the data graph (for example, using the raw data included in the data graph). As described above, the visualization layer may map data from the data graph on a map, on a timeline, within a graph, or the like. A user operating the user device 110 can interact with the visualization in various ways including but not limited to text input, selection of buttons or other mechanisms (real or virtual), gestures on a touchscreen or captured by a camera or similar device, verbal commands (for example, to bots), or the like. Also, using the expanded information in the data graph, a user can query, filter, pivot, and explore many more features and dimensions than those originally created. For example, using the expanded data graph, a user can query for all entities experiencing a particular type of weather (temperature), all entities traveling through a particular country or location on a particular day, all entities including sub-components from a particular facility, lot or batch, or country, and the like as these relationships and dimensions are represented in the stored data graph. For example, from any node and for any feature or value of a feature associated with a node, a user can expand and explore in any direction using the relationships and dimensions included in the stored data graph. As noted above, the driver 225 provides another level of modularity and separation between the data graph and the user device 110, which, like the visualization layers, allows a data graph to be generated once and provided through different types of user devices in different ways to take advantage of the technological benefits and developments of a particular type of user device.

FIG. 5 illustrates an example user interface displaying a visualization of a data graph, such as a provenance chain. A user may select a node with the data graph (for example, via an input device) to view additional information of the node (features of the node). Furthermore, a user can query or filter on these features. For example, in FIG. 5, a user can query or filter on an entity identifier (stock keeping unit (SKU)) 505, a stage identifier 510 (for example, manufacturing, packaging, and assembly), a supplier identifier 515, and a date range 520. As noted above, in some embodiments, additional features are available for use in querying, filtering, and pivoting that were identified through the expansion process, such as, for example, country of origin, weather, traffic, and the like. Accordingly, using this expanded information, a user can query on a particular country, manufacturing facility, temperature, air quality, employee satisfaction, and the like. Also, in some embodiments, a user can access information regarding the source of particular data included in the provenance chain, such as viewing whether information was included in the original provenance chain or was inferred and a source where the data (inferred or otherwise) was retrieved or generated from (including, for example, details of equipment used to by the source, a location of the source, a certification level of the source, the date the source was last accessed or last updated, an algorithm used to generate the data). For example, when the provenance chain includes temperature information, details regarding the sensors used to detect the temperatures (make or model) and the location of such sensors may be accessible through the provenance chain.

Accordingly, embodiments described herein create navigable data graphs, such as provenance chains, that, rather than being limited to arbitrary spaces or dimensions that are limited based on direct data recorded for an entity, are dynamic and include expanded information from various, often disconnected, data sources to improve the completeness and usefulness of the data graph to a end user. For example, when a provenance chain relates to a product, an expanded version of this chain generated using the methods and systems described herein may allow a user to not only trace a detected contamination back to source but also identify other products that may have been effected as well as identify causes for the contamination, such as particular weather conditions, working conditions, or the like. In particular, as described above, the systems and methods identify various dimensions that a data graph may be rendered in or related to and collect the information needed to provide such a rendering from one or more data sources. These relationships (dimensions) are stored with the data graph, which allows a user to quickly and efficiently (in terms of computing resource and bandwidth usage) query, filter, pivot, and generally explore a greater range of features and data associated with a particular entity. Furthermore, by creating such a data graph separate from any particular visualization or any particular software system or device, users are not limited in the types of visualizations that are available for various systems and devices. For example, rather than having to completely re-create an expanded data graph for each new type of visualization, software system, or device, the same data graph can be used, which improves computing resource use and user satisfaction.

Various features and advantages of some embodiments are set forth in the following claims.

What is claimed is:

1. A system for creating a data graph, the system comprising
a plurality of data sources; and
an electronic computing device, including an electronic processor, the electronic processor configured to
generate a data graph for an entity by accessing a plurality of data records stored in a first set of the plurality of data sources, wherein each of the plurality of data records is explicitly linked to the entity, the data graph including a plurality of connected nodes, wherein each of the plurality of nodes includes at least one feature representing a dimension of the data graph,
infer an additional dimension for the data graph based on data included in the data graph,
in response to confirming addition of the additional dimension to the data graph, add data to the data graph associated with the additional dimension by accessing data stored in a second set of the plurality of data sources, and
store the data graph with the data associated with the additional dimension.

2. The system according to claim 1, wherein the first set of the plurality of data sources is distinct from the second set of the plurality of data sources.

3. The system according to claim 2, wherein at least one data source included in the second set of the plurality of data sources is explicitly linked to the entity.

4. The system according to claim 1, wherein the data graph represents a provenance chain of the entity.

5. The system according to claim 4, wherein the first set of the plurality of data sources includes data sources generated at a plurality of stages of the entity.

6. The system according to claim 1, wherein the additional dimension includes at least one of time, location, weather, traffic, and socioeconomic status.

7. The system according to claim 1, wherein the additional dimension is inferred based on at least one of a data format, a data type, and a data name of the at least one feature.

8. The system according to claim 1, wherein the electronic processor is configured to infer the additional dimension using at least one of a library and a web service.

9. The system according to claim 1, wherein the electronic processor is further configured to calculate a probability value for the additional dimension.

10. The system according to claim 9, wherein the electronic processor is further configured to selectively prompt a user for confirmation of the additional dimension based on the probability value.

11. The system according to claim 9, wherein the electronic processor is further configured to selectively automatically link the additional dimension to the stored data graph based on the probability value.

12. The system according to claim 1, wherein the electronic processor is further configured to create a separate visualization layer for the stored data graph for generating a visualization of the stored data graph.

13. The system according to claim 12, wherein the visualization layer maps data included in the stored data graph to a position within the visualization.

14. The system according to claim 12, wherein the visualization of the stored data graph includes at least one of a map, a timeline, and a graph.

15. The system according to claim 1, wherein the confirmation is received from a user.

16. A method of creating a data graph, the method comprising
generating, with an electronic processor, a data graph for an entity by accessing a plurality of data records stored in a first set of a plurality of data sources, wherein each of the plurality of data records is explicitly linked to the entity, the data graph including a plurality of connected nodes, wherein each of the plurality of nodes includes at least one feature representing a dimension of the data graph,
inferring, with the electronic processor, an additional dimension for the data graph based on data included in the data graph,
in response to confirming addition of the additional dimension to the data graph, adding data to the data graph associated with the additional dimension by accessing data stored in a second set of the plurality of data sources, and
storing the data graph with the data associated with the additional dimension.

17. The method according to claim 16, wherein the additional dimension is inferred based on at least one of a data format, a data type, and a data name of the at least one feature.

18. Non-transitory computer-readable medium storing instructions that, when executed with an electronic processor, perform a set of functions, the set of functions comprising:
generating a data graph for an entity by accessing a plurality of data records stored in a first set of a plurality of data sources, wherein each of the plurality of data records is explicitly linked to the entity, the data graph including a plurality of connected nodes, wherein each of the plurality of nodes includes at least one feature representing a dimension of the data graph,
inferring an additional dimension for the data graph based on data included in the data graph,
in response to confirming addition of the additional dimension to the data graph, adding data to the data graph associated with the additional dimension by accessing data stored in a second set of the plurality of data sources, and
storing the data graph with the data associated with the additional dimension.

19. The non-transitory computer-readable medium according to claim 18, wherein the set of functions further comprises:
inferring the additional dimension using at least one of a library and a web service.

20. The non-transitory computer-readable medium according to claim 18, wherein the set of functions further comprises:
creating a separate visualization layer for the stored data graph for generating a visualization of the stored data graph.
